(19) United States
(12) Patent Application Publication
(10) Pub. No.: US 2008/0138663 A1
(43) Pub. Date: Jun. 12, 2008

(54) MICROBIAL ELECTRODE AND FUEL CELL AND SENSOR USING THE SAME

(75) Inventors: Wataru Kubo, Inagi-shi (JP); Tsuyoshi Nomoto, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/947,271

(22) Filed: Nov. 29, 2007

(30) Foreign Application Priority Data
Dec. 12, 2006 (JP) 2006-334383
Oct. 19, 2007 (JP) 2007-272684

(51) Int. Cl. H01M 8/16; C25B 11/06

(52) U.S. Cl. 429/2; 204/291; 204/403.14

(57) ABSTRACT

The present invention is directed to overcoming a problem of rate-limiting diffusion of a substrate toward an enzyme, which is a constituent of a microorganism, while ensuring proliferation of the microorganism, in a microbial electrode using a microorganism as an electrode catalyst. A microbial electrode is prepared using a microorganism expressing an enzyme on the surface layer of the cell membrane or cell wall thereof.

### BACKGROUND OF THE INVENTION

1. Field of the Invention

The present invention relates to a microbial electrode and application thereof.

2. Description of the Related Art

Electrodes using a biological substance as an electrode catalyst have been increasingly investigated. Of them, an enzyme electrode employing an enzyme as an electrode catalyst has been widely used as a biosensor by virtue of its high substrate selectivity and catalyst performance. Lately, it has been reported that fuel safer than before can be used by the application of such an enzyme electrode and accordingly a biofuel cell is developed. The biofuel cell has an advantage in that, despite its simple structure, it can generate sufficient power to drive a small electronic device. The enzyme electrode, however, has a disadvantage when it is used for a long time. Since the enzyme used as an electrode catalyst is a protein, the stability of the enzyme is limited.

On the other hand, investigation has been made on a microbial electrode in which a microorganism itself is used as an electrode catalyst. The microbial electrode has the following two advantages over an enzyme electrode.

1. An isolation/purification step of an enzyme from a microorganism is not required in preparing the electrode.

2. Since a microorganism can proliferate when a microbial electrode is placed in an appropriate environment, the electrode can be used for a long time.

Japanese Patent Application Laid-Open No. 2000-133297 discloses a method of generating power by immobilizing an electronic mediator to an electrode and using a microorganism as an electrode catalyst.

Furthermore, Japanese Patent Application Laid-Open No. 2006-085911 discloses a photoelectric cell using a microorganism or broken microorganism pieces as an electron donor.

However, as is shown in an embodiment of Japanese Patent Application Laid-Open No. 2000-133297 or Japanese Patent Application Laid-Open No. 2006-085911, when a microorganism is used as a catalyst, it is necessary for a substrate for an electrode reaction to pass through the cell membrane or the cell wall of the microorganism in order to reach the enzyme present in a microbial cell. Therefore, generally in a microbial electrode, the rate of a catalytic reaction is limited by the diffusion rate of the substrate. As a result, in the electrode using an enzyme as a catalyst, the catalyst activity of the microorganism is low compared to the case where a substrate reaches the enzyme without passing through the cell membrane. Therefore, a further improvement is desired. On the other hand, when a microorganism is broken into pieces as is described in Japanese Patent Application Laid-Open No. 2006-085911, the diffusion rate of a substrate can be improved; however, proliferation of the microorganism, which is an advantage of a microbial electrode, is unlikely performed. A further improvement is desired.

### SUMMARY OF THE INVENTION

In the circumstances, the present invention has been made with the view toward overcoming a problem of rate-limiting diffusion of a substrate toward an enzyme, which is a constituent of a microorganism, while ensuring proliferation of the microorganism, in a microbial electrode using a microorganism as an electrode catalyst.

According to a first aspect of the invention, there is provided a microbial electrode including an electroconductive member and a microorganism expressing an enzyme serving as an electrode catalyst, in which the enzyme is expressed on an outer surface layer of cell membrane or cell wall of the microorganism.

According to a second aspect of the invention, there is provided a device including a microbial electrode according to the present invention and an electrolyte solution in contact with the microbial electrode, wherein the electrolyte solution contains a substance required for proliferation of the microorganism of the microbial electrode.

According to a third aspect of the invention, there is provided a fuel cell using a microbial electrode according to the present invention as at least one of an anode and a cathode.

According to a fourth aspect of the invention, there is provided a sensor including a microbial electrode according to the present invention and a mean for applying voltage or potential to the microbial electrode.

According to the present invention, diffusion of a substrate, which has been a rate-limiting step of a catalytic reaction of the microbial electrode, can be improved while ensuring proliferation of a microorganism.

Further features of the present invention will become apparent from the following description of exemplary embodiments with reference to the attached drawings.

### BRIEF DESCRIPTION OF THE DRAWINGS

FIG. 1 is a conceptual view of a microbial electrode according to the present invention.

FIG. 2 is a schematic view of a fuel cell having a microbial electrode according to the present invention.

FIG. 3 is a schematic view of a sensor having a microbial electrode according to the present invention.

FIG. 4 is a conceptual view of the microbial electrode formed in Example 1.

FIG. 5 is a schematic view of the biofuel cell of Example 1.

FIG. 6 is a conceptual view of the microbial electrode formed in Example 2.

FIG. 7 is a schematic view of the glucose sensor of Example 2.

FIG. 8 is a schematic view of a fuel cell formed in Example 2.

FIG. 9A illustrates a graph indicating the relationship between substrate concentration and current characteristic with respect to a substrate sensor using a microbial electrode according to the present invention in comparison with that of a substrate sensor using a conventional microbial electrode.

FIG. 9B illustrates a graph indicating a change of the ratio of current/initial current with time with respect to a substrate sensor using a microbial electrode according to the present invention in comparison with that of that of a substrate sensor using a conventional microbial electrode.

FIG. 10A illustrates a graph indicating the relationship between current-voltage characteristic with respect to a fuel cell using a microbial electrode according to the present invention in comparison with that of a fuel cell using a conventional microbial (enzyme) electrode.

FIG. 10B illustrates a graph indicating a change of the ratio of power/initial power with time with respect to a fuel cell using a microbial electrode according to the present invention in comparison with that of a conventional microbial (enzyme) electrode.

FIG. 11A is the structure of an expression vector, recombinant plasmid pRSGoxAg, prepared in Example 1.

FIG. 11B is the structure of an expression vector, recombinant plasmid pYRGox prepared in Example 1.

### DESCRIPTION OF THE EMBODIMENTS

### First Embodiment

### Microbial Electrode

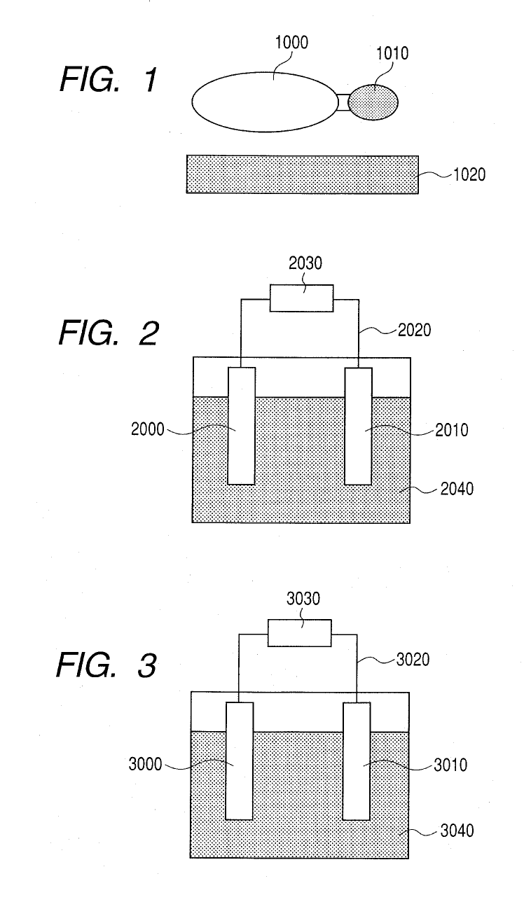

A conceptual view of a microbial electrode according to the present invention is shown in FIG. 1. In the figure, reference numeral 1000 indicates a microorganism, 1010 an enzyme, and 1020 an electroconductive member.

The invention according to this embodiment uses a microorganism expressing an enzyme on the surface layer of the cell membrane or the cell wall thereof. Since an enzyme serving as a catalyst is present on the surface layer of a cell of the microorganism, a substrate can reach the enzyme without passing through the cell membrane or cell wall. As a result, the diffusion rate of the substrate, which limits the rate of a catalytic reaction, can be improved.

1) Re: Microorganism Expressing the Enzyme on the Surface Layer of the Cell Membrane or the Cell Wall

Recently, a desired foreign protein has been able to be expressed and displayed on the surface layer of a host cell by designating the expression site of a protein present inside and outside the cell by manipulating gene information based on the signal theory on a protein. The present invention uses a microorganism which expresses an enzyme on the outer surface layer of the cell membrane or the cell wall thereof. However, as the original host microorganism, any microorganism may be used as long as it can express an enzyme on the surface layer. Examples of the microorganism include yeast, Escherichia coli and lactobacillus. Of them, yeast is desirable since it is easily handled. As an example, baker's yeast, Saccharomyces cerevisiae, may be mentioned. In Saccharomyces cerevisiae, various types of proteins can be displayed on the surface layer of the cell by manipulating the molecular information of agglutinin, which is a cohesive intercellular adhesion protein inducibly expressed when cells are joined with each other and present in the outermost shell of the surface layer of the cell.

In the microorganism to be used in the present invention, in order to expose an enzyme on the outer surface of the cell membrane or cell wall of the microorganism, the enzyme is allowed to fuse with a polypeptide having a function of holding the enzyme so as to expose on the outer surface layer of the cell membrane or cell wall and wholly or partly expressed. As the polypeptide having such a function, for example, a membrane bound protein (anchoring protein) can be suitably used. This is attained, for example, by the following method. DNA encoding the whole or part of a desired enzyme is ligated with DNA encoding a membrane bound protein (anchoring protein) so as to align the reading frames with each other and introduced in a vector selected according to a host cell to prepare an expression vector. Subsequently, the expression vector thus prepared is introduced into a host cell to transform it. As the expression vector, a generally known vector such as a plasmid, phage or virus can be used.

The expression vector for expressing the whole or part of an enzyme on the outer surface layer of the cell membrane or cell wall of a microorganism has, as a constituent, a DNA sequence having a function of transferring the enzyme fused with an anchoring protein to the cell membrane or cell wall. When such a DNA sequence is translated, the translated polypeptide may have a signal sequence or a function involved in intracellular transport. Alternatively, such a DNA sequence itself may carry out the function. Alternatively, any tool (or method) that a person skilled in the art may conceive may be applied.

As examples of the constituent of an expression vector for transferring the enzyme to the surface layer of a cell and held while exposing it to outside the cell, the following DNA sequences may be mentioned.

DNA encoding a secretory signal sequence (simply referred to as “sig1”),

DNA encoding the whole or part of a desired enzyme (simply referred to as “enz1”)

DNA encoding an anchoring protein for immobilizing the whole or part of a desired enzyme on the surface layer of a cell (simply referred to as “anch1”).

These constituents are connected while reading frames thereof are aligned with each other in the order of sig1-enz1-anch1 or sig1-anch1-enz1 and then ligated to constituents of an expression vector such as a promoter, selection marker and terminator. In this manner, the enzyme can be expressed.

When an enzyme according to the present invention is an oligomer including a dimer, one of the subunits of the enzyme is allowed to contain a peptide fused with a protein capable of binding to the surface layer of a cell. When the subunit containing such a fusion protein and another subunit containing no fusion protein are simultaneously expressed, such a functional enzyme can be exposed on the surface layer of a cell.

When the constituent of the enzyme capable of being exposed on the surface layer of the cell membrane or cell wall of a microorganism is an oligomer including a dimer, the expression vector (referred to as a “first expression vector”) may further contain a constituent (sig2-enz2) in which DNA (sig2) encoding a promoter, selective marker, terminator and secretory signal sequences and DNA (enz2) encoding the whole or part of a desired enzyme subunit are ligated with reading frames aligned.

The additional constituent may be ligated to the first expression vector in cis configuration or introduced in a second vector to prepare a second expression vector. When the second expression vector is prepared, a host cell is transformed twice with the first and second expression vectors.

The promoter, secretory signal sequence, selection marker, terminator, and anchoring protein to be used in the expression vector are not particularly limited as long as they are generally used in the host cell to be employed. As a method of introducing a vector into a host cell, a known method such as an electroporation method or lithium acetate method can be used.

A microorganism expressing an enzyme on the surface of a cell may be prepared not only by introducing an expression vector into a cell, thereby express the enzyme but also by transfecting a linear DNA to integrate into the genome, thereby stably expressing the enzyme.

As a microorganism according to the present invention, a microorganism capable of adhering to an electroconductive member can be used. When the microorganism adhesive to an electroconductive member is used, it is not necessary to use a mechanism (holding membrane) for preventing a microorganism from leaking into an electrolyte solution. Since the mechanism is not used, the supply of a substrate to an enzyme may not be reduced.

The enzyme for use in this embodiment is an enzyme (oxidoreductase) catalyzing an oxidation-reduction reaction. Examples of the oxidoreductase include a dehydrogenase, reductase, oxidase, oxygenase and hydroperoxoidase. However, any type of enzyme may be used. More specifically, other oxidoreductases including glucose oxidase, horseradish peroxidase, bilirubin oxidase, laccase, thioredoxin reductase are generally used. Furthermore, these enzymes may be used in combination with another type of enzyme. For example, glucose oxidase may be used in combination with α-glycosidase.

When an enzyme is externally introduced into a microorganism and expressed therein, the enzyme to which genetic engineering technique can be applied is desirably used. A microorganism having a gene for the enzyme cloned therein may be used. When an enzyme of a living organism is used, the enzyme whose sequence (the sequence of the region encoding the enzyme) has been elucidated can be used.

The gene of an enzyme may be derived from any type of living organism as long as it can be expressed on the outer surface layer of the cell membrane or cell wall of a microorganism. For example, when glucose oxidase is expressed on the surface layer of a yeast cell, the gene of glucose oxidase may be cDNA (SEQ ID No: 16) derived from Aspergillus niger (ATCC 9029) or cDNA (SEQ ID No: 17) derived from Penicillium Amagasakiense (ATCC 28686). As a gene for horseradish peroxidase, cDNA (SEQ ID No: 18) derived from Armoracia Rusticana may be used. As a gene for glucose dehydrogenase, cDNA (SEQ ID No: 19) derived from Bacillus subtilis (ATCC 2737) may be used. As the gene for alcohol dehydrogenase, cDNA (SEQ ID No: 20) derived from Saccharomyces cerevisiae S288C (ATCC 26108) may be used.

When an enzyme according to the present invention expressed on the surface layer of a cell requires a prosthetic group such as a flavin compound, a metal atom such as Fe, Cu, or Mo, or heme to produce its catalytic activity, such a prosthetic group may be supplied, for example, by the following manner. A prosthetic group may be added in a medium in advance, thereby reconstituting an apoenzyme expressed on the surface layer of a cell as a holoenzyme. Examples of a combination of an enzyme and a prosthetic group include glucose oxidase and flavin adenine dinucleotide; horseradish peroxidase and heme; bilirubin oxidase and Cu; and laccase and Cu.

A substrate for an enzyme according to the present invention varies depending upon the enzyme. Examples of the substrate include an organic substance, oxygen, hydrogen peroxide, water and nitrate ion. Furthermore, examples of the organic substance include a saccharide, alcohol, carboxylic acid, quinone, nicotine amide derivative and flavin derivative. Polysaccharide such as cellulose and sugar may be included in the examples of saccharide.

2) Re: Electroconductive Member

As an electroconductive member according to the present invention, a metal material, carbon material, metal oxide and electroconductive polymer may be used. Examples of the metal material include gold and platinum. Examples of the carbon material include graphite and carbon black. Examples of the metal oxide include indium tin oxide (ITO). Examples of the electroconductive polymer include a polyacetylene and a polyarylene. Of them, a carbon material and metal oxide can be desirably used.

The adhesiveness of a microorganism to an electroconductive member depends upon the combination of the microorganism and the electroconductive member and the ambient environment. Therefore, the adhesiveness of a microorganism to an electroconductive member includes not only the adhesiveness of the microorganism to a common feature of electroconductive members but also the adhesiveness of the microorganism to a specific feature of the electroconductive member employed in practice. To render an electroconductive member to be adhesive to a microorganism, the surface of the electroconductive member may be coated with an organic material such as a polymer, thiol compound or silane compound or an inorganic material such as alumina or silica. The state of a microorganism adhered to such an electroconductive member in this manner may be included in the present invention as an aspect of the adhesiveness to an electroconductive member. As an example of the combination of a microorganism adhesive to an electroconductive member and an electroconductive member, the combination of Saccharomyces cerevisiae and an alumina member (pH 3.0 to 9.5) may be mentioned. When a microorganism is not adhesive to an electroconductive member (an electrode), the microorganism may be held by a holding membrane within the region where the microorganism can work as an electrode catalyst. As an example of the holding membrane, dialysis membrane may be mentioned.

3) Re: Electrolyte Solution

An electrolyte solution according to the present invention desirably has a sufficient degree of conductivity to perform an electrode reaction, electrochemical stability, and safety for survival and proliferation of a microorganism. The environment required for survival and proliferation of a microorganism greatly differs depending upon the microorganism to be employed. The conditions of the environment to be controlled include a solvent (generally containing water as a major component), temperature, pH, dissolved gas concentration, salt concentration and concentration of each nutrient. The electrolyte may be an organic substance or an inorganic substance, and liquid, solid, or gel. Examples of the electrolyte include metal salts such as KCl, NaCl, MgCl₂, NH₄Cl and Na₂HPO₄, alkali such as NH₄OH, KOH and NaOH, and aqueous solutions of acid such as H₃PO₄ and H₂SO₄.

An electrolyte solution dissolving a substance required for microbial proliferation can be used. Examples of the substance required for microbial proliferation vary depending upon the type of microorganism and include components used in a general microbial medium.

4) Re: Mediator

A microbial electrode according to the present invention or an electrolyte solution in contact with the microbial electrode can contain a mediator for mediating transport of charge from an active center of an enzyme exposed on the surface layer of a microorganism to the conductive member, as needed.

The mediator to be used in the present invention refers to a substance that accelerates transfer between the enzyme expressed on the surface layer of a microorganism and the electroconductive member. An oxidation-reduction substance generally used in the field of biological electrochemistry may be used as the mediator. Examples of the mediator include a quinone, metal complex, heterocyclic compound, nicotine amide derivative and flavin derivative. The mediator may be immobilized onto the electroconductive member in order to prevent, for example, its leakage into the electrolyte solution or contained in the electrolyte solution. When a microbial electrode according to the present invention is used as a device, a mediator having an effective oxidation and reduction potential effective for the device may be selected. If the mediator is appropriately selected, a biofuel cell capable of providing high voltage and a substrate sensor less affected from an interfering substance can be prepared. As a method of immobilizing a mediator to an electroconductive substance, a known method may be applied. For example, a method using an organic material such as a polymer, thiol compound and silane compound may be mentioned.

### Second Embodiment

### Fuel Cell

As an exemplary embodiment of the present invention, a fuel cell may be mentioned. A fuel cell having a microbial electrode according to the present invention will be described with reference to FIG. 2. The microbial electrode is used in place of either one of an anode 2000 and a cathode 2010 in the figure. The electrodes are connected to work load 2030 by way of lead wire 2020. 2040 indicates electrolyte solution. The anode and cathode are placed in contact with an electrolyte solution. If necessary, a mechanism holding the electrolyte solution may be used. When a fuel, that is, a substrate for an enzyme, is present in the electrolyte solution, electromotive force is generated between the anode and the cathode. Since electric current can be supplied by the electromotive force to the work load, the work load can perform its work. When a microbial electrode according to the present invention reacts with a positive electrode active material, it donates electrons, thereby mediating an electrode reaction as a positive electrode. In contrast, when a microbial electrode according to the present invention reacts with a negative electrode active material, it receives electrons, thereby mediating an electrode reaction as a negative electrode. Whether a microbial electrode serves as a positive electrode or a negative electrode is determined depending upon a type of enzyme to be expressed.

When a microbial electrode is used as an anode, use may be made of a microorganism capable of expressing an enzyme, which catalyzes a reaction for oxidizing a substance (generally fuel) serving as a substrate for an anode reaction. Examples of a combination of such an enzyme and the corresponding substance to the enzyme include glucose oxidase and glucose; glucose dehydrogenase and glucose; and alcohol dehydrogenase and ethanol. On the other hand, when a microbial electrode is used as a cathode, use may be made of a microorganism capable of expressing an enzyme, which catalyzes a reaction for reducing a substance (generally oxygen) serving as a substrate for a cathode reaction. Examples of a combination of such an enzyme and the corresponding substance to the enzyme may include laccase and bilirubin oxidase.

A fuel cell is typically constructed of a reaction vessel capable of storing an electrolyte solution containing a substance serving as fuel, an anode and a cathode arranged at a predetermined interval in the reaction vessel. A microbial cell is employed as at least one of the anode and the cathode.

The work load used herein is, for example, a pump for supplying a chemical agent, a transmitter for transmitting the electric signal obtained from an electrode to the outside, and a camera for taking an image.

### Third Embodiment

### Sensor

One of the exemplary embodiments of the present invention is a sensor. The sensor using a microbial electrode according to the present invention will be described with reference to FIG. 3. In the figure, a microbial electrode 3000 and an opposite electrode 3010 are connected to an external apparatus 3030 by way of lead wire 3020. The microbial electrode and the opposite electrode are arranged in contact with an electrolyte solution 3040. If necessary, a mechanism for holding a reference electrode and the electrolyte solution can be applied.

The sensor device can detect the presence or absence and concentration of a test substance present in the electrolyte solution based on the electric signal obtained by the external apparatus 3030 through the microbial electrode. In this manner, a sensor to which the microbial electrode is applied can be attained. Note that examples of the electric signal include electric current, electric charge, voltage, potential and impedance. Alternatively, electric signals such as potential and voltage may be previously applied to the microbial electrode from the external apparatus. If the relationship between an electric signal and a specific substrate concentration is stored in a database in advance, the obtained electric signal can be compared to the information stored in the database.

In such a sensor device, a microbial electrode is used a detection unit for detecting a substance. Therefore, any substance can be detected without particular limit as long as it can be detected by the microbial electrode. The substrate for an enzyme expressed on the surface layer of a microorganism serving as an electrode can be selectively detected. The sensor device may be used, for example, as a glucose sensor, fructose sensor, galactose sensor, amino acid sensor, amine sensor, cholesterol sensor, alcohol sensor, lactic acid sensor, oxygen sensor and hydrogen peroxide sensor. More specifically, the sensor device may be used as sensors for determining a blood glucose level, a lactic acid level and a sugar content of a fruit, and an alcohol sensor for determining the alcohol level of expired air.

### EXAMPLES

The present invention will be described more specifically by way of examples below; however, the method of the present invention will not be limited by the examples.

### Example 1

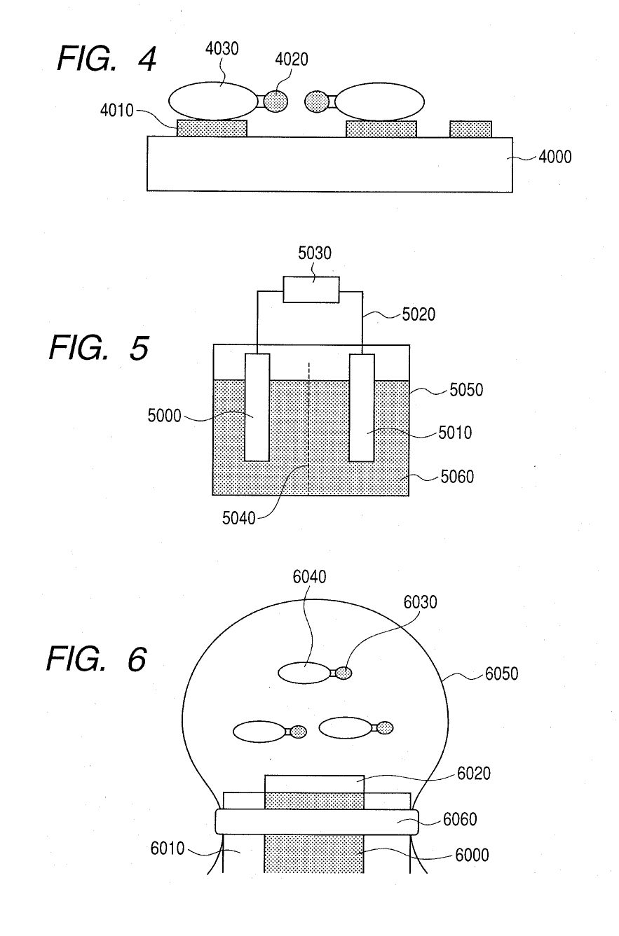

A conceptual view of the microbial electrode formed in this example is shown in FIG. 4. In the figure, a conductive member has an ITO conductive glass substrate 4000 and alumina particles 4010. On the surface layer of the conductive member, a microorganism, Saccharomyces cerevisiae 4030 adheres, which has an enzyme (glucose oxidase 4020) exposed.

Since glucose oxidase is exposed on the surface layer of the cell membrane of Saccharomyces cerevisiae, glucose serving as a substrate can reach glucose oxidase without passing through the cell membrane. As a result, the diffusion rate of a substance can be prevented from decreasing, thereby preventing low current supply.

In this example, preparation of a microbial electrode (enzyme electrode) and application of the electrode to a biofuel cell will be described sequentially in this order.

1. Preparation of Saccharomyces cerevisiae having glucose oxidase exposed on the surface layer of a cell

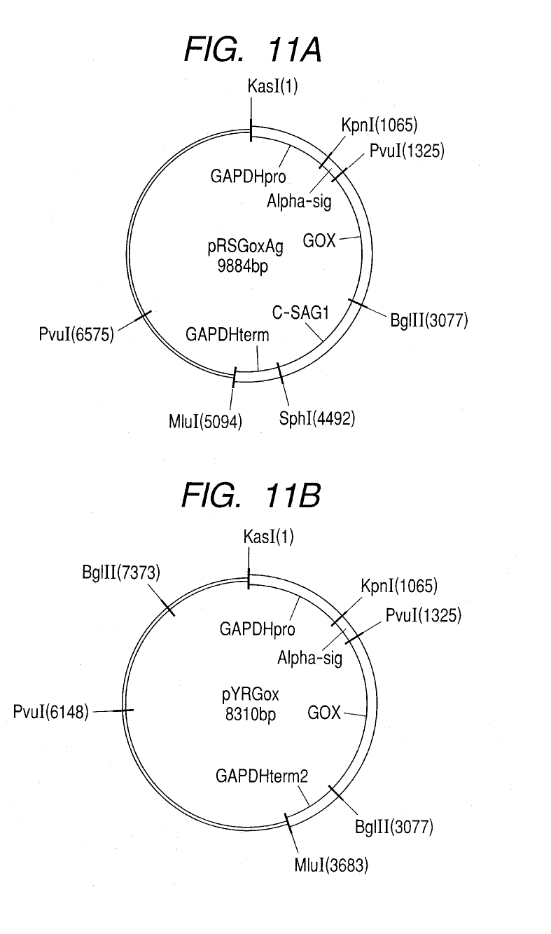

First, a plasmid having the structure shown in FIGS. 11A and 11B is prepared in the manner as described below.

A PCR amplification reaction is performed using the genomic DNA of Saccharomyces cerevisiae S288C (ATCC 26108) is used as a template and synthetic oligonucleotides of SEQ. ID Nos. 1 and 2 (Table 1) as primers to obtain an amplified product (GAPDHpro) having about 1054 base pairs. The DNA fragment (GAPDHpro) contains a promoter for glyceraldehyde 3-phosphate dehydrogenase. Note that a microorganism (including the vectors that will be mentioned later) whose name is described together with a deposit number is available from a public institution such as the American Type Culture Collection (ATCC) of the United States.

Then, a PCR amplification reaction is performed using the genomic DNA of Saccharomyces cerevisiae S288C (ATCC 26108) as a template and synthetic oligonucleotides of SEQ. ID Nos. 3 and 4 (Table 1) as primers to obtain an amplified product (alpha-sig) having about 255 base pairs. The DNA fragment (alpha-sig) contains a secretory signal for an α-factor.

These two DNA fragments, GAPDHpro and alpha-sig, are digested with restriction enzyme KpnI and ligated to obtain a DNA fragment (GAPDHpro::alpha-sig) having about 1340 base pairs.

Subsequently, cDNA is prepared from cultured cells of Aspergillus niger (ATCC 9029) according to a customary method. A PCR amplification reaction is performed using the cDNA as a template and synthetic oligonucleotides of SEQ. ID Nos. 5 and 6 (Table 1) as primers to obtain an amplified product (GOX) having about 1749 base pairs. The DNA fragment (GOX) encodes glucose oxidase. The two DNA fragments, GAPDHpro::alpha-sig and GOX are digested with restriction enzyme PvuI and ligated to obtain a DNA fragment (GAPDHpro::alpha-sig::GOX) having about 3076 base pairs.

Subsequently, a PCR amplification reaction is performed using the genomic DNA of Saccharomyces cerevisiae S288C (ATCC 26108) as a template and synthetic oligonucleotides of SEQ. ID Nos. 7 and 8 (Table 1) as primers to obtain an amplified product (C-SAG1) having about 1406 base pairs. The DNA fragment (C-SAG1) contains 320 amino acids at the 3′ side of an α-agglutinin gene and a 3′ flanking region having 446 base pairs.

The two DNA fragments, GAPDHpro::alpha-sig::GOX and C-SAG1, are digested with restriction enzyme BglII and ligated to obtain a DNA fragment (GAPDHpro::alpha-sig::GOX::C-SAG1) having about 4491 base pairs.

Subsequently, a PCR amplification reaction is performed using the genomic DNA of Saccharomyces cerevisiae S288C (ATCC 26108) as a template and synthetic oligonucleotides of SEQ. ID Nos. 9 and 10 (Table 1) as primers to obtain an amplified product (GAPDHterm) having about 600 base pairs. The DNA fragment (GAPDHterm) contains a terminator of glyceraldehyde 3-phosphate dehydrogenase.

The two DNA fragments, GAPDHpro::alpha-sig::GOX::C-SAG1 and GAPDHterm, are digested with restriction enzyme SphI and ligated to obtain a DNA fragment (GAPDHpro::alpha-sig::GOX::C-SAG1:: GAPDHterm) having about 5093 base pairs.

Subsequently, a PCR amplification reaction is performed using the genomic DNA of Saccharomyces cerevisiae S288C (ATCC 26108) as a template and synthetic oligonucleotides of SEQ. ID Nos. 11 and 10 (Table 1) as primers to obtain an amplified product (GAPDHterm2) having about 600 base pairs. The DNA fragment (GAPDHterm2) contains a terminator for glyceraldehyde 3-phosphate dehydrogenase.

The two DNA fragments, GAPDHpro::alpha-sig::GOX and GAPDHterm2 are digested with restriction enzyme BglII and ligated to obtain a DNA fragment (GAPDHpro::alpha-sig::GOX::C-SAG1::GAPDHterm2) having about 3696 base pairs.

Subsequently, a PCR amplification reaction is performed using plasmid pRS426 (ATCC 77107) as a template and synthetic oligonucleotides of SEQ. ID Nos. 12 and 13 (Table 1) as primers to obtain an amplified product (RS426) having about 4785 base pairs.

The two DNA fragments, GAPDHpro::alpha-sig::GOX::C-SAG1::GAPDHterm, and RS426 are digested with restriction enzymes KasI and MluI and ligated to obtain an expression vector (pRSGoxAg).

Subsequently, a PCR amplification reaction is performed using plasmid Yrp7 (ATCC 37060) as a template and synthetic oligonucleotides of SEQ. ID Nos. 14 and 15 (Table 1) as primers to obtain an amplified product (YR7) having about 4622 base pairs.

TABLE 1

PCR primer sequence

| | | | |
|---|---|---|---|
| Amplified | | Restriction | SEQ ID |
| product | Primer sequence | enzyme | No: |

| | | | |
|---|---|---|---|
| GAPDHpro | 5′ -aataatGGCGCCaccagttctcacacggaacaccactaatgg-3′ | KasI | 1 |
| | 5′ -aataatGGTACCtttgtttgtttatgtgtgtttattcgaaac-3′ | KpnI | 2 |
| alpha-sig | 5′ -aataatGGTACCatgagatttccttcaatttttactgcagtt-3′ | KpnI | 3 |
| | 5′ -aataatCGATCGtcttttatccaaagataccccttcttctttag-3′ | PvuI | 4 |
| GOX | 5′ -aataatCGATCGagcaatggcattgaagccagcctcctgact-3′ | PvuI | 5 |
| | 5′ -aataatAGATCTctgcatggaagcataatcttccaagatagc-3′ | BglII | 6 |
| C-SAG1 | 5′ -aataatAGATCTgccaaaagctcttttatctcaaccactac-3′ | BglII | 7 |
| | 5′ -aataatGCATGCtttgattatgttctttctatttgaatgaga-3′ | SphI | 8 |
| GAPDHterm | 5′ -aataatGCATGCgtgaatttactttaaatcttgcatttaaat-3′ | SphI | 9 |
| | 5′ -aataatACGCGTttttacatttctggtgttgaagggaaagat-3′ | MluI | 10 |
| GAPDHterm2 | 5′ -aataatAGATCTgtgaatttactttaaatcttgcatttaaat-3′ | BglII | 11 |
| | 5′ -aataatACGCGTttttacatttctggtgttgaagggaaagat-3′ | MluI | 10 |
| RS426 | 5′ -aataatGGCGCCcctgatgcggtattttctccttacgcatct-3′ | KasI | 12 |
| | 5′ -aataatACGCGTactgcccgctttccagtcgggaaacctgtc-3′ | MluI | 13 |
| YR7 | 5′ -aataatGGCGCCacggtgcctgactgcgttagcaatttaact-3′ | KasI | 14 |
| | 5′ -aataatACGCGTggaagccggcggcacctcgctaacggattc-3′ | MluI | 15 |

*The region of a primer sequence indicated by capital letters is the sequence recognized by restriction enzyme shown in the right-end column thereof.

The two DNA fragments, GAPDHpro::alpha-sig::GOX::GAPDHterm 2 and YR7 are digested with restriction enzymes KasI and MluI and ligated to obtain an expression vector (pYRGox).

The two expression vectors, pRSGoxAg and pYRGox, are introduced in Saccharomyces cerevisiae PTY33 (ATCC MYA-1747) according to a lithium acetate method. The resultant double transformed yeast cell is cultured in SDC medium free from uracil and tryptophane and containing a flavin adenine dinucleotide at 30° C. for 96 hours.

Since the promoter for glyceraldehyde 3-phosphate dehydrogenase is a constitutive expression promoter, it can express an enzyme on the surface layer of a cell at any cell proliferation phase.

The functional unit of glucose oxidase is a dimer. Therefore, a peptide containing a C-SAG1 sequence and a peptide containing no C-SAG1 sequence are allowed to express simultaneously. In this manner, a functional enzyme can be exposed on the surface layer of a cell.

2. Preparation of Microbial Electrode

A commercially available ITO conductive glass (e.g., ITO glass manufactured by Kuramoto Co., Ltd.) is coated with a diluted suspension solution of commercially available fine alumina particles (e.g., manufactured by Micron) by spin-coating, dried, baked and treated with UV-ozone to prepare a hydrophilic electroconductive substrate member coated with alumina particles.

The electroconductive substrate member thus prepared is placed in a liquid yeast medium, (e.g., a solution containing glucose, yeast nitrogen base, adenine sulfate, L-histidine hydrochloride, L-leucine and uracil) and microorganism cells are seeded on the substrate member to prepare an electroconductive member attached with a microorganism.

3. Preparation of Biofuel Cell

FIG. 5 shows a schematic view of a biofuel cell according to this example. The biofuel cell of the example has an electrolyte solution containing a mediator. The biofuel cell has a microbial electrode 5000 serving as anode, a platinum line 5010 serving as a cathode. They are connected to work load 5030 (e.g., liquid crystal display device) by way of lead wire 5020. In a container 5050 which is physically separated (but electrically connected) by a separator 5040 into an anode vessel and a cathode vessel, an electrolyte solution (5060) which is the liquid yeast medium containing an electrolyte (e.g., ammonium chloride), glucose serving as fuel and oxygen is supplied. To the anode vessel, commercially available N-methylphenazonium methyl sulfate serving as a mediator is added and dissolved in the solution in a concentration of 0.5 mM. In this manner, electromotive force is generated to drive the liquid crystal display device.

### Example 2

A conceptual view of the microbial electrode formed in this example is shown in FIG. 6. The microbial electrode of the example has a metal complex polymer as a mediator on the surface of an electroconductive substrate member. In the figure, reference numeral 6000 indicates grassy carbon, 6010 a resin in which the grassy carbon is embedded. A metal complex polymer 6020 is immobilized in the grassy carbon. Saccharomyces cerevisiae (6040) having glucose oxidase 6030 exposed on the surface layer thereof is held by means of dialysis membrane 6050 and a rubber ring to fix 6060.

Since glucose oxidase is exposed on the surface layer of the cell membrane of Saccharomyces cerevisiae, glucose serving as a substrate can reach to Saccharomyces cerevisiae without passing through the cell membrane. As a result, the diffusion rate of a substance can be prevented from decreasing, thereby preventing low current supply.

Now, preparation of the microbial electrode (enzyme electrode) and the application of the electrode to a glucose sensor and biofuel cell will be described sequentially in this order.

1. Synthesis of metal complex polymer

A method of synthesizing a complex represented by Formula (1) below will be described.

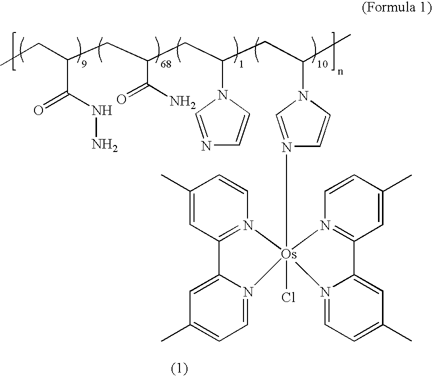

To ethylene glycol serving as a solvent, an equivalent of (NH)₂[OsCl₆] and two equivalents of 4,4′-dimethyl-2-2′-bipyridine were placed and stirred and refluxed by a microwave synthesizer (Milestone Microsynth). The resultant solution was allowed to cool in the air and an aqueous solution of Na₂S₂O₄ was added to the solution and stirred to obtain a black purple precipitate. The precipitate was separated by filtration and washed with water, followed with diethyl ether and dried to obtain Os(4,4′-dimethyl-2,2′-bipyridine)₂Cl₂. To water serving as a solvent, 8 equivalents of acrylamide and an equivalent of 1-vinylimidazole, and N,N,N′,N′-tetramethylethylenediamine were added. To the reaction solution, ammonium persulfate was added and the reaction was performed at 40° C. under nitrogen flow and then cooled in the air. Reprecipitation was performed with ethanol while the resultant solution was vigorously stirred. A precipitate was dried to obtain a copolymer containing polyacrylamide and polyvinylimidazole in a ratio of 7.49:1. ¹HNMR (D₂O) analysis was performed to determine the molecular configuration and the unit ratio of the copolymer.

To a solvent mixture of ethylene glycol and ethanol, Os(4,4′-dimethyl-2,2′-bipyridine)₂Cl₂ and a copolymer of polyacrylamide-polyvinylimidazole were added and refluxed in a microwave synthesizer under nitrogen flow. The resultant solution was cooled in the air and reprecipitation was performed with a diethyl ether solution. A precipitate was dried to obtain the desired complex polymer represented by Formula (1).

2. Preparation of Microbial Electrode

On the grassy carbon electrode embedded in a resin (e.g., manufactured by B.A.S), an aqueous solution of the complex polymer prepared above and polyethylene glycol diglycidyl ether are placed dropwise and dried overnight. Then, the suspension solution of yeast (Saccharomyces cerevisiae) having glucose oxidase exposed on the surface layer of the cell membrane and prepared in Example 1 is placed dropwise and covered with a commercially available dialysis membrane with the help of the O ring.

3. Measurement of Glucose Level

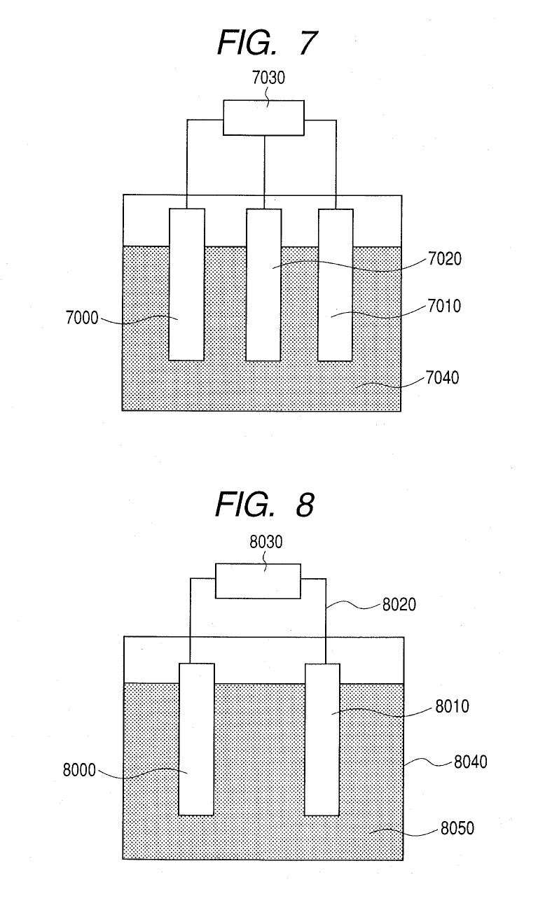

FIG. 7 shows a schematic view of a glucose sensor according to this example. The microbial electrode prepared above is used as a working electrode 7000. A platinum line is used as the opposite electrode 7010. A silver/silver chloride electrode is used as a reference electrode 7020. In this manner, a three-electrode cell is prepared and connected to a potentiostat 7030. As an electrolyte solution 7040, a glucose-free liquid yeast medium (e.g., a solution containing yeast nitrogen base, adenine sulfate, L-histidine hydrochloride, L-leucine and uracil) is used. Before measurement, a calibration curve is prepared by adding glucose whose concentration is known, applying a potential of 500 mV vs Ag/AgCl to the working electrode to measure a constant current (catalyst current). The electrolyte solution is exchanged with a fresh electrolyte solution and a substance containing glucose in an unknown concentration is added to the electrolyte solution. The concentration of glucose is measured by applying the same potential as above and measuring a constant current.

4. Preparation of Biofuel Cell

FIG. 8 shows a schematic view of a biofuel cell according to this Example. A microbial electrode 8000 serving as an anode electrode and a platinum line 8010 serving as a cathode are connected to work load 8030, for example, a liquid crystal display device, by way of lead wire 8020. To a container 8040, a liquid yeast medium, electrolyte (e.g., ammonium chloride), glucose serving as fuel, and an electrolyte solution 8050 containing oxygen are supplied. In this manner, electromotive force is generated to drive the liquid crystal display device.

(Effect Shown in Example)

In a microbial electrode according to the present invention, a microorganism having an enzyme exposed on the cell membrane or cell wall thereof by use of a genetic engineering technique is used as an electrode catalyst. As a result, the microbial electrode is advantageous over conventional one using a microorganism in that diffusion of a substrate toward the enzyme is improved because the substrate is diffused to the enzyme without passing though the cell membrane or cell wall.

As described above, the diffusion of a substrate, which is a rate-limiting step in a conventional microbial electrode, is improved in the microbial electrode of the present invention. As a result, a microbial electrode exhibiting a higher current value than conventional ones can be prepared.

Furthermore, the microorganism can proliferate when it is placed in an appropriate environment. Therefore, the microbial electrode of the present invention is a biocatalyst electrode having a long cycle life compared to a conventional enzyme electrode.

The characteristic of the microbial electrode is applicable as follows (1) to (4).

(1) The microbial electrode of the present invention can supply a large amount of current compared to conventional microbial electrodes at the same substrate concentration. When the electrode having such a characteristic is applied to a sensor, a highly sensitive sensor having a lower detection limit can be obtained. Furthermore, when the microbial electrode is applied to a fuel cell, the fuel cell having a high current density and a high power density which increased in proportional to the current density can be provided.

(2) In the microbial electrode of the present invention, a current value per microbial cell can be increased compared to conventional microbial electrodes. In other words, the microbial electrode of the present invention can provide a requisite current value by use of a lower amount of microorganism. Therefore, the amount of microorganism put in use can be reduced, which contributes to reduction of a natural source and cost required for production of the electrode.

(3) In the microbial electrode of the present invention, a current value per microbial cell can be increased compared to conventional microbial electrodes. In other words, the microbial electrode of the present invention can provide a requisite current value by use of a lower amount of microorganism. Therefore, when the microbial electrode of the invention has the same density of microorganism cells as the conventional microbial electrodes, the area of the electrode providing the same output current value and charge amount as the conventional one can be reduced. When the area of the electrode is reduced in this way, the background current can be reduced. As a result, a single/noise ratio can be improved. In addition, the size of a device using the microbial electrode can be reduced. In this manner, a low-noise sensor, miniaturized sensor and miniaturized fuel cell can be provided.

(4) Use of the microbial electrode of the present invention enables to provide a biocatalyst electrode device having a long cycle life compared to conventional microbial electrodes (enzyme electrodes). As a result, a long-life sensor and fuel cell can be provided.

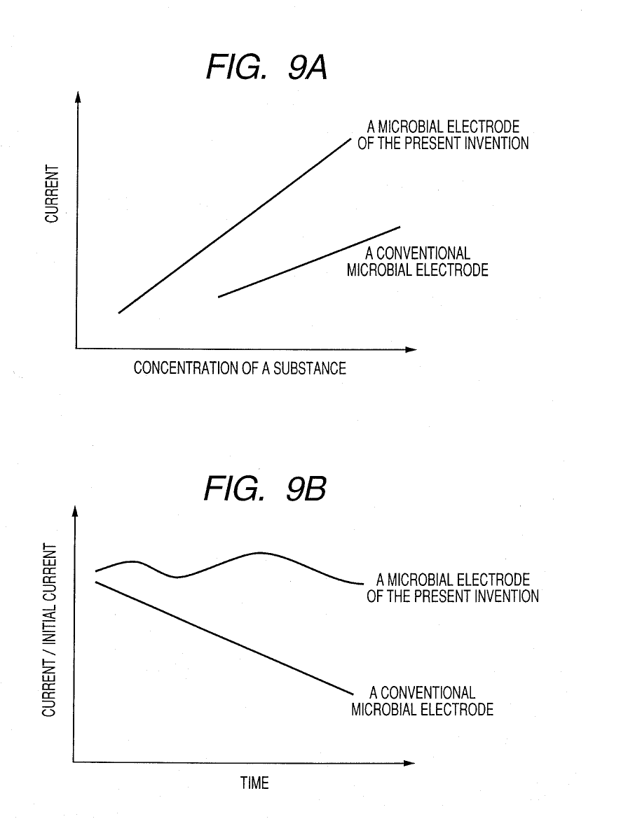

FIG. 9A shows a graph indicating the relationship between substrate concentration and current characteristic of a substrate sensor using advantages of a microbial electrode according to the present invention. A substrate sensor using a microbial electrode 9000 according to the present invention shows a higher current value compared to a sensor using a conventional microbial electrode 9010 and a lower detection limit.

FIG. 9B shows a graph indicating a change of the ratio of current/initial current with time with respect to a substrate sensor using the advantages of a microbial electrode according to the present invention. When a substrate sensor 9020 using a microbial electrode according to the present invention is held in an appropriate environment, it shows a long life compared to a sensor using a conventional microbial electrode 9030 (enzyme electrode) although a ratio of current/initial current greatly fluctuates conceivably due to an increase/decrease of microbial cells.

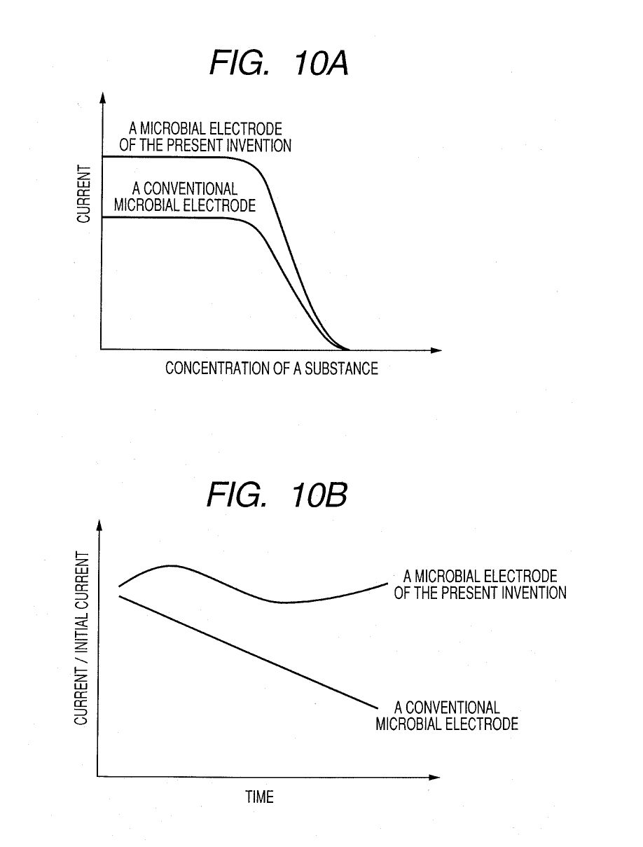

FIG. 10A shows a graph indicating the relationship between current-voltage characteristics of a fuel cell using the advantages of a microbial electrode according to the present invention. The substrate sensor using a microbial electrode 10000 according to the present invention exhibits a high current value and maxim power compared to a fuel cell using a conventional microbial electrode 10010.

FIG. 10B shows a graph indicating a change of the ratio of power/initial power with time of a fuel cell using the advantages of a microbial electrode according to the present invention. When a fuel cell 10020 using a microbial electrode according to the present invention is held in an appropriate environment, it shows a long life compared to a fuel cell using a conventional microbial electrode 10030 (enzyme electrode) although a ratio of current/initial current greatly fluctuates conceivably due to an increase/decrease of microbial cells.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2006-334383, filed Dec. 12, 2006, and No. 2007-272684, filed Oct. 19, 2007, which are hereby incorporated by reference herein in their entirety.

What is claimed is:

1. A microbial electrode comprising an electroconductive member and a microorganism expressing an enzyme serving as an electrode catalyst, wherein the enzyme is expressed on an outer surface layer of cell membrane or cell wall of the microorganism.

2. The microbial electrode according to claim 1, wherein the microorganism has adhesiveness to the electroconductive member, thereby attaching onto a surface of the member.

3. A device comprising the microbial electrode according to claim 1 and an electrolyte solution in contact with the microbial electrode, wherein the electrolyte solution contains a substance required for proliferation of the microorganism of the microbial electrode.

4. The device according to claim 3, wherein at least one of the surface of electroconductive member of the microbial electrode and the electrolyte solution further contains a mediator.

5. A fuel cell using the microbial electrode according to claim 1, as at least one of an anode and a cathode.

6. A sensor comprising the microbial electrode according to claim 1 and a unit for applying voltage or potential to the microbial electrode.


SEQUENCE LISTING (20 sequences)

SEQ ID NO: 1 - DNA, 42 bp, Artificial
  PCR primer
aataatggcgccaccagttctcacacggaacaccactaatgg

SEQ ID NO: 2 - DNA, 42 bp, Artificial
  PCR primer
aataatggtacctttgtttgtttatgtgtgtttattcgaaac

SEQ ID NO: 3 - DNA, 42 bp, Artificial
  PCR primer
aataatggtaccatgagatttccttcaatttttactgcagtt

SEQ ID NO: 4 - DNA, 44 bp, Artificial
  PCR primer
aataatcgatcgtcttttatccaaagataccccttcttctttag

SEQ ID NO: 5 - DNA, 42 bp, Artificial
  PCR primer
aataatcgatcgagcaatggcattgaagccagcctcctgact

SEQ ID NO: 6 - DNA, 42 bp, Artificial
  PCR primer
aataatagatctctgcatggaagcataatcttccaagatagc

SEQ ID NO: 7 - DNA, 41 bp, Artificial
  PCR primer
aataatagatctgccaaaagctcttttatctcaaccactac

SEQ ID NO: 8 - DNA, 42 bp, Artificial
  PCR primer
aataatgcatgctttgattatgttctttctatttgaatgaga

SEQ ID NO: 9 - DNA, 42 bp, Artificial
  PCR primer
aataatgcatgcgtgaatttactttaaatcttgcatttaaat

SEQ ID NO: 10 - DNA, 42 bp, Artificial
  PCR primer
aataatacgcgtttttacatttctggtgttgaagggaaagat

SEQ ID NO: 11 - DNA, 42 bp, Artificial
  PCR primer
aataatagatctgtgaatttactttaaatcttgcatttaaat

SEQ ID NO: 12 - DNA, 42 bp, Artificial
  PCR primer
aataatggcgcccctgatgcggtattttctccttacgcatct

SEQ ID NO: 13 - DNA, 42 bp, Artificial
  PCR primer
aataatacgcgtactgcccgctttccagtcgggaaacctgtc

SEQ ID NO: 14 - DNA, 42 bp, Artificial
  PCR primer
aataatggcgccacggtgcctgactgcgttagcaatttaact

SEQ ID NO: 15 - DNA, 42 bp, Artificial
  PCR primer
aataatacgcgtggaagccggcggcacctcgctaacggattc

SEQ ID NO: 16 - DNA, 1818 bp, Aspergillus niger
atgcagactctccttgtgagctcgcttgtggtctccctcgctgcggccctgccacactacatcaggagcaatggcattgaagccagcctcctgactgatcccaaggatgtctccggccgcacggtcgactacatcatcgctggtggaggtctgactggactcaccaccgctgctcgtctgacggagaaccccaacatcagtgtgctcgtcatcgaaagtggctcctacgagtcggacagaggtcctatcattgaggacctgaacgcctacggcgacatctttggcagcagtgtagaccacgcctacgagaccgtggagctcgctaccaacaatcaaaccgcgctgatccgctccggaaatggtctcggtggctctactctagtgaatggtggcacctggactcgcccccacaaggcacaggttgactcttgggagactgtctttggaaatgagggctggaactgggacaatgtggccgcctactccctccaggctgagcgtgctcgcgcaccaaatgccaaacagatcgctgctggccactacttcaacgcatcctgccatggtgttaatggtactgtccatgccggaccccgcgacaccggcgatgactattctcccatcgtcaaggctctcatgagcgctgtcgaagaccggggcgttcccaccaagaaagacttcggatgcggtgacccccatggtgtgtccatgttccccaacaccttgcacgaagaccaagtgcgctccgatgccgctcgcgaatggctacttcccaactaccaacgtcccaacctgcaagtcctgaccggacagtatgttggtaaggtgctccttagccagaacggcaccacccctcgtgccgttggcgtggaattcggcacccacaagggcaacacccacaacgtttacgctaagcacgaggtcctcctggccgcgggctccgctgtctctcccacaatcctcgaatattccggtatcggaatgaagtccatcctggagccccttggtatcgacaccgtcgttgacctgcccgtcggcttgaacctgcaggaccagaccaccgctaccgtccgctcccgcatcacctctgctggtgcaggacagggacaggccgcttggttcgccaccttcaacgagacctttggtgactattccgaaaaggcacacgagctgctcaacaccaagctggagcagtgggccgaagaggccgtcgcccgtggcggattccacaacaccaccgccttgctcatccagtacgagaactaccgcgactggattgtcaaccacaacgtcgcgtactcggaactcttcctcgacactgccggagtagccagcttcgatgtgtgggaccttctgcccttcacccgaggatacgttcacatcctcgacaaggacccctaccttcaccacttcgcctacgaccctcagtacttcctcaacgagctggacctgctcggtcaggctgccgctactcaactggcccgcaacatctccaactccggtgccatgcagacctacttcgctggggagactatccccggtgataacctcgcgtatgatgccgatttgagcgcctggactgagtacatcccgtaccacttccgtcctaactaccatggcgtgggtacttgctccatgatgccgaaggagatgggcggtgttgttgataatgctgcccgtgtgtatggtgtgcagggactgcgtgtcattgatggttctattcctcctacgcaaatgtcgtcccatgtcatgacggtgttctatgccatggcgctaaaaatttcggatgctatcttggaagattatgcttccatgcagtga

SEQ ID NO: 17 - DNA, 1818 bp, Penicillium amagasakiense
atggtgtctgtatttctcagcactcttcttttatctgcggctgcggtccaagcctacctgcctgcccaacagattgatgtccagtctagtcttctcagtgaccctagcaaggttgcaggaaagacctatgattacatcattgctggtggtggtttgactggccttactgttgctgccaaattgacagaaaaccccaagatcaaagtcctggtcattgaaaagggcttctatgagtccaacgatggagccatcatcgaggatccaaatgcttatggacaaatctttggcaccactgttgaccagaactacctcaccgttcccctgatcaacaaccgcacgaacaatatcaaggccggtaaaggtcttggaggatcaaccttgataaacggtgactcctggactcgcccagacaaagtccagattgattcttgggagaaggtctttggcatggaaggttggaattgggacaacatgttcgagtacatgaagaaggccgaggctgcacgtacccctactgctgctcagcttgctgctggccactccttcaatgctacctgccatggaaccaacggtactgttcaatccggagcccgtgacaacggccagccttggtctcctattatgaaggcccttatgaacaccgtctcggcccttggtgtccccgtacagcaagactttctctgtggtcatcctcgaggtgtctctatgatcatgaacaatctcgacgaaaaccaagttcgtgttgatgctgcccgtgcatggctgcttcccaactaccagcgctcgaatttggagatccttactggtcagatggttggaaaggttctgtttaaacagaccgcatccggtccccaggctgttggtgtgaacttcggtactaataaggccgtcaactttgacgtctttgctaagcatgaggtccttttggctgctggctcagctatctctccgctgatcttggaatattctggcataggcttgaagtctgttcttgatcaagccaatgtcactcagcttcttgatcttcctgttggtatcaatatgcaagatcagaccacaaccactgtcagttcccgtgctagttccgctggtgctggtcagggtcaggccgtcttcttcgccaatttcactgagaccttcggtgactacgccccccaggccagggacttactcaacaccaagctcgaccaatgggccgaggagaccgttgcgcgcggtggtttccataatgtaactgctctcaaagtacaatacgaaaactatcgtaactggctccttgacgaagacgtcgccttcgccgagcttttcatggacaccgagggcaagatcaacttcgatttatgggatctcatccctttcactcgtggttccgtccatatcctcagtagcgatccttacctatggcaattcgccaacgaccccaaattcttcctgaacgagtttgacctccttggtcaagctgccgcttccaagcttgctcgtgatctcactagccaaggcgctatgaaggagtacttcgccggggagactcttccaggatacaacttggtccagaatgctactctttcccagtggtcggattatgtcttacagaacttccgtcccaactggcatgctgtgagcagctgctctatgatgtctagagagcttggtggtgtcgttgatgctactgccaaggtgtacggtacccaaggcctacgtgtcattgacgggtctattcctccgactcaggtgtcttcccatgtcatgaccattttctacggaatggctttgaaggttgctgatgccattttggatgactatgccaaaagtgcctag

SEQ ID NO: 18 - DNA, 924 bp, Armoracia rusticana
caacttacccctaccttctacgacaattcatgtcctaatgtctctaacatcgtacgggatactattgtcaatgagctaagatcagaccctcgtattgccgcgagcatccttcgtcttcacttccacgactgctttgttaatggttgtgacgcatcgatcttgttagacaacacaacatcatttcgaacagagaaagatgcgtttggaaacgcaaactcggcaagaggatttccagtgattgatagaatgaaagccgcggtggagagtgcatgcccaagaaccgtttcatgcgcagatttgctcaccattgcagctcaacaatctgtcactttggcgggaggtccttcttggagagttcctttgggcagaagagatagcttacaagcatttctggatcttgctaatgcaaatcttccagctccattcttcacacttccacaacttaaagacagctttagaaatgttggcctcaaccgttcttctgatctcgttgcactgtccgggggccacacatttggtaaaaatcagtgtcggtttattatggacagattatacaacttcagcaacaccggtttacccgatcctactctcaacactacttatctccaaactcttcgtggactatgtcccctcaatggtaatctaagcgctttggtggattttgatctacgtacgccaacgatttttgacaacaaatactatgtgaatctcgaagaggaaaaaggacttatccaaagcgaccaagagttgttctctagccccaatgccactgacacaatccctttggtgagatcatttgctaatagcacacaaacattcttcaatgcatttgtggaggcgatggataggatgggaaacattacacctcttacaggaactcaaggacagatcaggttgaattgtagggtggtgaactccaactct

SEQ ID NO: 19 - DNA, 786 bp, Bacillus subtilis
atgtatccggatttaaaaggaaaagtcgtcgctattacaggagctgcttcagggctcggaaaggcgatggccattcgcttcggcaaggagcaggcaaaagtggttatcaactattatagtaataaacaagatccgaacgaggtaaaagaagaggtcatcaaggcgggcggtgaagctgttgtcgtccaaggagatgtcacgaaagaggaagatgtaaaaaatatcgtgcaaacggcaattaaggagttcggcacactcgatattatgattaataatgccggtcttgaaaatcctgtgccatctcacgaaatgccgctcaaggattgggataaagtcatcggcacgaacttaacgggtgcctttttaggaagccgtgaagcgattaaatatttcgtagaaaacgatatcaagggaaatgtcattaacatgtccagtgtgcacgaagtgattccttggccgttatttgtccactatgcggcaagtaaaggcgggataaagctgatgacagaaacattagcgttggaatacgcgccgaagggcattcgcgtcaataatattgggccaggtgcgatcaacacgccaatcaatgctgaaaaattcgctgaccctaaacagaaagctgatgtagaaagcatgattccaatgggatatatcggcgaaccggaggagatcgccgcagtagcagcctggcttgcttcgaaggaagccagctacgtcacaggcatcacgttattcgcggacggcggtatgacacaatatccttcattccaggcaggccgcggttaa

SEQ ID NO: 20 - DNA, 1056 bp, Saccharomyces cerevisiae
atgccttcgcaagtcattcctgaaaaacaaaaggctattgtcttttatgagacagatggaaaattggaatataaagacgtcacagttccggaacctaagcctaacgaaattttagtccacgttaaatattctggtgtttgtcatagtgacttgcacgcgtggcacggtgattggccatttcaattgaaatttccattaatcggtggtcacgaaggtgctggtgttgttgttaagttgggatctaacgttaagggctggaaagtcggtgattttgcaggtataaaatggttgaatgggacttgcatgtcctgtgaatattgtgaagtaggtaatgaatctcaatgtccttatttggatggtactggcttcacacatgatggtacttttcaagaatacgcaactgccgatgccgttcaagctgcccatattccaccaaacgtcaatcttgctgaagttgccccaatcttgtgtgcaggtatcactgtttataaggcgttgaaaagagccaatgtgataccaggccaatgggtcactatatccggtgcatgcggtggcttgggttctctggcaatccaatacgcccttgctatgggttacagggtcattggtatcgatggtggtaatgccaagcgaaagttatttgaacaattaggcggagaaatattcatcgatttcacggaagaaaaagacattgttggtgctataataaaggccactaatggcggttctcatggagttattaatgtgtctgtttctgaagcagctatcgaggcttctacgaggtattgtaggcccaatggtactgtcgtcctggttggtatgccagctcatgcttactgcaattccgatgttttcaatcaagttgtaaaatcaatctccatcgttggatcttgtgttggaaatagagctgatacaagggaggctttagatttcttcgccagaggtttgatcaaatctccgatccacttagctggcctatcggatgttcctgaaatttttgcaaagatggagaagggtgaaattgttggtagatatgttgttgagacttctaaatga